(19) United States
(12) Patent Application Publication
(10) Pub. No.: US 2010/0209563 A1
(43) Pub. Date: Aug. 19, 2010

(54) Frozen beverage and method for making the same

(76) Inventor: Michael David Mark, Las Vegas, NV (US)

Correspondence Address: Michael D. Mark, 821 Donelle Ave., Las Vegas, NV, 89123, US

(21) Appl. No.: 12/378,524

(22) Filed: Feb. 17, 2009

(51) Int. Cl. A23G 3/50

(52) U.S. Cl. 426/104; 426/515

(57) ABSTRACT

A frozen beverage containing dissolvable substances. The frozen beverage is frozen solid, forming chambers for liquid to touch pertaining walls. The addition of liquid in these pathways causes the dissolvable substances to dissolve. This dissolving separates the particles in the frozen substance, leaving the high melting point substances to remain frozen. The frozen beverage may be mixed by hand or by mechanical means after separation.

### CROSS-REFERENCE TO RELATED APPLICATIONS

This application claims the benefit of provisional patent application Ser. No. 05/035,908, filed Mar. 7, 1972 by Speech; Ser No. 129,840, filed Mar. 9, 1937 by London; Ser. No. 05/311,997, filed Jul. 29, 1975 by Homier; Ser. No. 05/582,435, filed May 30, 1975 by Adams; and Ser. No. 04/777,486, filed Nov. 20, 1968 by LeVan.

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to frozen beverages, specifically to such beverages that use the addition of liquid to dissolve substances in a frozen mixture.

2. Prior Art

Grocery stores, supermarkets and gas stations commonly sell frozen products consisting or intending on producing a textured beverage compared with that of a smoothie or slush. Each of these frozen beverages produces a product with frozen particles of ice which gives it's drinkers a cool crisp sensation. It is these frozen particles that make them such a delicacy and a summer favorite.

Gas stations and many merchants sell premade slush products in which you fill yourself. These products contain high sugar ratios that allows them to be constantly stirred and not freeze. These starches lower the freezing point of the substance but raise the calories and fat content in the product. Do to this need for syrup, almost none of these products have any fruit content or daily nutritional value. The high ratio of sugar to water and the slow freezing process causes crystallization of the ice. This crystallization creates large particles of solids which are unwanted due to their large scale. Also their machinery to maintain their temperature and texture comes at a hefty price.

Similar products are seen in grocery stores and supermarkets produced in the form of pouches and cups. These products commonly have similar nutritional problems. Many methods have been approached when creating a solution of this nature. U.S. Pat. No. 6,511,693 to Jones (2003) and U.S Pat. No. 4,808,428 to Forsstrom 1989 attempted to solve this problem by creating individual serving pouches. These servings contained high amounts of sugars and gums to lower the freezing point of the substances inside. This lower freezing point allows the consumer to mash apart the particles in the malleable packets. U.S Pat. No. 5,246,725 to Fisher 1993; U.S Pat. No. 5,698,247 to Hall (1997); and U.S Pat. No. 5,866,191 to Mancuso (1999) attempted to solve this dilemma by dividing the product into individual cups for spooning. Containing excess gums and starches, these products often settle to the bottom leaving the high freezing point substances at the top to freeze. Commonly you are asked to crush the packets mixture by hand or grind them with a spoon which can be tiresome. These products rely on your temperature of your freezer to be of a standard. If your freezer is too low the product may entirely freeze, causing them to be impossible to crush by hand. If your freezer is too high the product may entirely melt, leaving you with a sugary liquid. These products are sold in bundles and commonly of a small assortment of flavors, if any, in a box.

In an attempt to solve these problems, predetermined mixtures of fruit are sold. These mixes of diced fruit and concentrate rely on you to make the measurements yourself. Each packet requires you to have a blending apparatus and all the ingredients such as water, ice, milk, yogurt, sugar, etc. Much of the flavor is lost because the frozen fruit cannot emit their flavors. These products rely on the consumer to obtain a transporting container.

### OBJECTS AND ADVANTAGES

Accordingly, my product's objects and advantages will solve all of the problems previously expressed and more. Several objects and advantages of the present invention are:
(a) to provide a frozen beverage product which can be with produced with the only addition of water;
(b) to provide a frozen beverage product which can be flash frozen creating a smooth texture minimizing crystallization;
(c) to provide a frozen beverage product which can be made easily by hand;
(d) to provide a frozen beverage product which contain all the nutritional benefits of a real fruit smoothie and not have the high sugar content;
(e) to provide a frozen beverage product which can be individually sold in many assortments of flavors;
(f) to provide a frozen beverage product which can maintain its form in any freezer temperature;
(g) to provide a frozen beverage product which you do not need an apparatus or measurements to create;
(h) to provide a frozen beverage product whose solid frozen structure can withstand long and harsh temperature periods of hot air;
(i) to provide a frozen beverage product which allows the user to determine the mixture of liquids to add such as water, dairy, or alcohol;
(j) to provide a frozen beverage product which allows the user to add supplements to the product;
(l) to provide a frozen beverage product which does not need pricy machinery to maintain its consistency;
(k) to provide a frozen beverage product whose fruit content will melt first, expressing the fruits full flavor;
(l) to provide a frozen beverage product whose solid frozen substance mixture is hard and will hold its from in transportation and stocking;
(m) to provide a frozen beverage product whose solid form will hold its starches and gums from settling.
   Still further objects and advantages will become apparent from the consideration of the ensuing description;

### SUMMARY

In accordance with the present invention, an addition of liquid into a frozen substance blend, a frozen substance blend formed into a designated design for holding liquid, this frozen substance blend contains substances that will dissolve with the addition of liquid, creating a frozen beverage.

### DRAWINGS—FIGURES

In the drawings, closely related figures have the same number but different alphabetic suffixes.

FIGS. 1A to 1D show various aspects of a frozen substance blend designed with pathways for water intake.

### REFERENCE NUMERALS

10. Circular hole 12. ¼ ring hole
14. Side 16. Corner ridge
18. Bridge 20. Inner ring
22. Corner 26. Base ridge

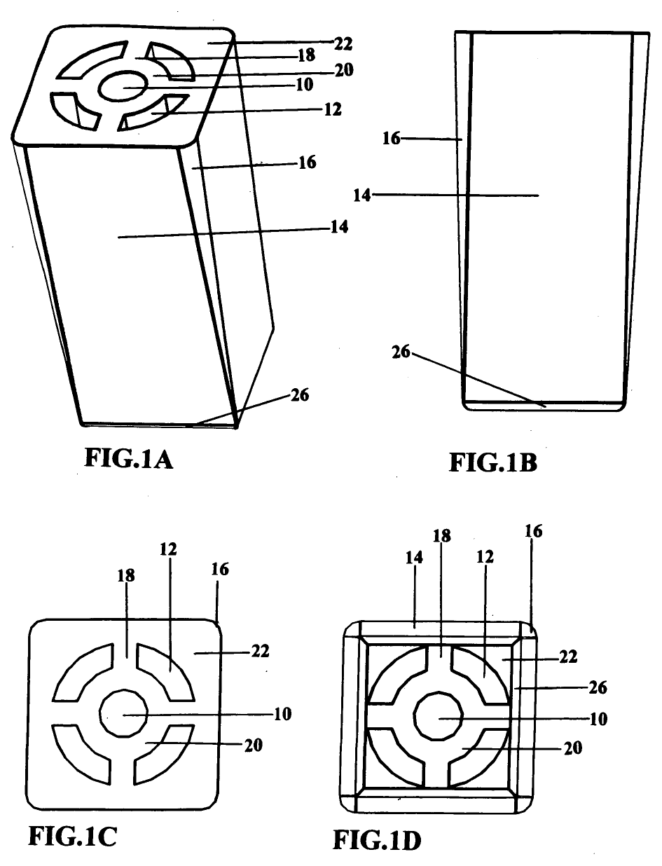

### DETAILED DESCRIPTION—FIGS. 1A to 1D—PREFERRED EMBODIMENTS

The preferred embodiment of the frozen substance blend of the present invention is illustrated in FIG. 1A (isometric view), FIG. 1B (side view), FIG. 1C (top view), and FIG. 2D (bottom view). The frozen substance blend is typically made of blended fruit, dairy products, and ice which is flash frozen to reduce crystallization at −60 degrees Fahrenheit or below until solid. The frozen substance blend will contain a high percentage of water to hold its structure solid. The frozen substance blend will contain 1 gram of sugar for every 5 ml of frozen substance.

This frozen substance blend is to be contained in a bottle with its four sides 14, corner ridge 16, base ridge 26, and base contouring the bottle's inner structure. The containing bottle will have air room above and through the frozen substance's circular hole 10 and four ¼ rings 12 creating a 1 to 1 ratio of air to frozen substance. The containing bottle will designate a level to add liquid designated by a fill line around the bottle. The designated fill line typically will allow the addition of 0.8 ml to 1.0 cm3 of frozen substance blend.

The frozen substance blend contains a circular hole 10, that hollows out the center evenly through the figure from top to bottom. Four ¼ ring 12 holes, hollow out an outer ring evenly from top to the bottom in the frozen substance blend. Four bridges 18 connect the center ring 14 with the outsides of the frozen substance blend. The circular hole 10 and the four ¼ rings 12 should combine to allow the addition of liquid amounting in 65 percent of the total frozen substance blend's mass. The base ridge 26 and corner ridge 16 are rounded preventing substances to stick in corners wile freezing and being mixed. The four sides 14 slope inwards towards the base.

### Operation—FIGS. 1

Through the creation of the structure presented above, the product has inlets for water while still maintaining its structural integrity. The corner ridge 16 allows large loads of pressure to be administered before collapsing. The corner ridge 16 will distribute the pressure's load through the frozen beverages sides 14, distributing the pressure around the outside border. The four sides 14 also are designed to absorb large loads of pressure before collapsing. The four sides 14 will directly take the impact and pass it through the bridge 18. The bridge 18 after accepting the pressure load will distribute the pressure load through the inner ring 20 and throughout the product. The frozen beverage blend with its high percent of water will stay solid until liquid is added.

With the addition of liquid the dissolvable substances such as sugars and gums will dissolve. The addition of liquid will fill the circular hole 10, the four ¼ rings 12, and overlap the top of the frozen beverage substance blend. Because sugars and gums are the lowest freezing point substances, they will dissolve while the higher melting point products remain frozen. This interchange of temperatures will equalize the temperature of the newly combined frozen substance blend. This equalization allows the substance blend with the newly added water to remain in a smoothie or slush like state for long periods. The dissolvable substances will soften the structure of the frozen substance blend after releasing the ice particles that they previously surrounded by dissolving.

The once hard frozen substance blend is now malleable. The angled sides 14 create a higher ratio of water towards the base of frozen substance blend. This ratio allows the base of the frozen substance blend to absorb equal amounts of liquid as the flooded top of the frozen substance blend. Squeezing the four sides 14, the frozen substance blend including the added liquid will shift upwards due to the angled sides 14. Squeezing the four sides 14 will also collapse the bridges 18 thus, freeing the inner ring 20 and the corners 22. The upwards shift sets the frozen substance blend into a wider location whereas the added liquid can now surround the four sides 14, corner ridge 16, base ridge 26, and base. The structure and design of the current frozen substance blend increases the surface area the added liquid can touch. The circular hole 10 and the four ¼ ring holes 12 create an inlet where water can travel through and around the frozen substance blend.

The newly collapsed and malleable frozen substance blend can now be mixed by hand thus spreading the newly added liquid equally as the temperature equalizes. The corner ridge 16 and base ridge 26 will cause the frozen substance blend to not become clumped while mixing.

### Alternative Embodiments

There are many various ways in which to approach creating alternative embodiments. The preferred embodiment's design of the frozen substance blend utilizes the addition of liquid. The frozen substance blend's design increases the surface area which can be touched by liquid. These alternative embodiments use the same concept as the preferred embodiment by utilizing the addition of liquid to create a reaction. Alternative embodiments may include, add, or remove the current preferred embodiment's designs such as the circular hole 10 and the four ¼ ring holes 12. The bottle design may be altered by moving the fill line which would change the amounts of liquid to be added. Changing this fill line will create a smoother, thicker or a blend that is easier to mix. Substitutes of the embodiment have their own unique utility based off the structure of the frozen substance blend. There are various possibilities with regard to the actions set forth to create this frozen beverage product. As you can see, the dispositions of the substance mixture may vary to create new flavors or consistencies. The openness of the presented invention's attributes makes it so unique and adaptable.

### Operation—Additional Embodiments

Similar to the preferred embodiment's operation, the additional embodiment's addition of liquid is necessary to stimulate the change to create this beverage. The disposition and design of the frozen substance blend may vary, but still containing dissolvable substances, the frozen substance blend will still react in a similar manner as the preferred embodiment.

From the description above, a number of advantages of my frozen beverage process become evident:
(a) to provide a frozen beverage product which can be with produced with the only addition of water;
(b) to provide a frozen beverage product which can be flash frozen creating a smooth texture minimizing crystallization;
(c) to provide a frozen beverage product which can be made easily by hand;
(d) to provide a frozen beverage product which contain all the nutritional benefits of a real fruit smoothie and not have the high sugar content;
(e) to provide a frozen beverage product which can be individually sold in many assortments of flavors;
(f) to provide a frozen beverage product which can maintain its form in any freezer temperature;
(g) to provide a frozen beverage product which you do not need an apparatus or measurements to create;
(h) to provide a frozen beverage product whose solid frozen structure can withstand long and harsh temperature periods of hot air;
(i) to provide a frozen beverage product which allows the user to determine the mixture of liquids to add such as water, dairy, or alcohol;
(j) to provide a frozen beverage product which allows the user to add supplements to the product;
(l) to provide a frozen beverage product which does not need pricy machinery to maintain its consistency;
(k) to provide a frozen beverage product whose fruit content will melt first, expressing the fruits full flavor;
(l) to provide a frozen beverage product whose solid frozen substance mixture is hard and will hold its from in transportation and stocking;
(m) to provide a frozen beverage product whose solid form will hold its starches and gums from settling.

### Conclusion, Ramifications, and Scope

Accordingly, the reader will see that the frozen beverage process presented can be easily used to create unique beverages in an easy manner. This technique allows consumers to always have a frozen beverage ready without the blender, ingredients, or specific measurements. This process allows the user to have the choice of flavor in their frozen beverage and the choice to choose what liquid to add in the creation of their frozen beverage. It is these options that make this process so unique. With the advantage of a designed frozen substance blend for holding liquid, the consumers will always have a delicious frozen beverage whenever they choose.

Although the description above contains much specificity, these should not be construed as limiting the scope of the invention but as merely providing illustrations of some of the presently preferred embodiments of this invention. For example: the design of the frozen substance, the substance blend's ratios, the steps to create this frozen beverage, etc.

Thus, the scope of the invention should be determined by the appended claims and their legal equivalents, rather than by the examples given.

I claim:

1. A method of preparing a frozen beverage, comprising:
(a) providing a frozen substance blend containing dissolvable substances, formed into a designated design for holding liquid,
(b) addition of said liquid into said designated design initiating separation by dissolving, whereby said liquid and said substance blend can be mixed.

2. The frozen beverage of claim 1 wherein said frozen substance blend is frozen into a designated shape increasing its perimeter.

3. The frozen beverage of claim 1 wherein said liquid is water.

4. The frozen beverage of claim 1 wherein said liquid is a dairy product.

5. The frozen beverage of claim 1 wherein said liquid is alcohol.

6. The frozen beverage of claim 1 wherein said frozen substance blend is contained in a receptacle.

7. In a frozen substance blend containing dissolvable substances wherein said frozen substance blend is formed into a designated design for holding liquid.

8. The frozen substance blend of claim 7 wherein said designated design increases its perimeter.

9. The frozen substance blend of claim 7 wherein said dissolvable substances are sugar.

10. The frozen substance blend of claim 7 wherein said dissolvable substances are gum.

11. The frozen substance blend of claim 7 wherein said frozen substance blend is contained in a receptacle.
